(19) United States
(12) Patent Application Publication
(10) Pub. No.: US 2010/0037229 A1
(43) Pub. Date: Feb. 11, 2010

(54) Method and Device for Determining a Target State

(75) Inventors: Philipp Woerz, Heilbronn (DE); Mathias Bieringer, Illingen (DE); Alexander Schaefer, Heilbronn (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/308,202

(22) PCT Filed: Sep. 20, 2007
(86) PCT No.: PCT/EP2007/059985

§ 371 Date: Sep. 1, 2009

(30) Foreign Application Priority Data
Oct. 5, 2006 (DE) 10 2006 047 141.5

(51) Int. Cl. G06F 9/46

(52) U.S. Cl. 718/103

(57) ABSTRACT

In a method for determining a target state in a system having multiple components, system states of different priorities being selectable in the system as a function of an availability of the components, the following steps are provided: ascertaining whether a highest-priority system state is selectable; determining the highest-priority system state as the target state if the highest-priority system state is selectable; and ascertaining whether a next-higher-priority system state is selectable if the highest-priority system state is not selectable, and determining the next-higher-priority system state as the target state if said state is selectable.

### BACKGROUND OF THE INVENTION

1. Field of the Invention

The present invention relates to a method and a device for determining a target state in a system, e.g., ESP, having multiple components.

2. Description of Related Art

Published German patent document DE 102 23 368 describes a method with which system states of a control device can be ascertained from ambient conditions that have been read in.

Published German patent document DE 103 54 659 describes a method according to which each of a plurality of interacting devices proposes an operating mode, and a common operating mode is selected from all the proposed operating modes.

What is referred to hereinafter is, substantially, an electronic stability program that can be used, for example, in the automobile sector.

A variety of hardware components are used in electronic stability programs (ESPs). The term “hardware components” encompasses, in this connection, sensors, actuators, data transfer controllers, and control device components of all kinds. The data transfer controllers can involve, for example, CAN or Flex-Ray. The control device components encompass, for example, ROM, RAM, EEPROM, or A/D controllers.

All the aforementioned hardware components, and the signals that are transferred or supplied by the hardware components, are monitored during their operation in order to recognize possible failures. A present state of a component or of a signal is referred to as a “status.” Possible statuses are, for example, “valid,” “short-term invalid,” “not initialized,” and “invalid.” Within the “not initialized” status, multiple gradations are possible.

Because the ESP is a safety-relevant system, it is necessary to establish, in the event of malfunctions in operation, a safe state with maximum residual availability. The ESP therefore contains a variety of fallback levels, generally referred to as system states, that can be occupied in the event of a malfunction. A “system state” is understood as the combination of the states of all components present in the system. The components are, for example, controllers, model calculation components, monitoring components, or signal conditioning components.

The location in the overall vehicle system at which these malfunctions occur is irrelevant in this context. Possible fault sources are ESP-internal sensors and actuators, but also signals that are furnished or received from outside systems, for example via CAN. The particular level, or “target state,” that is occupied depends on the type of malfunction.

Another factor that influences the target state is a user of the system. In the example of an ESP this is the driver, who can deliberately deactivate individual portions of the ESP functionality using, for example, the “passive” or “ESP off” button. This driver input can be referred to in general as a “trigger.” In a present-day ESP the trigger is processed, in contrast to faults, using separate algorithms.

Analogously, a manufacturer of the system or a manufacturer of a higher-level system can make further stipulations. Taking the example of an ESP, the automobile manufacturer can, at the completion of production, program the ESP control device so that certain functions are deactivated, because the end customer has not specifically ordered and paid for them. These manufacturer inputs can also be placed into the “trigger” category.

At present, the target state in an ESP is ascertained in distributed fashion. This distribution of tasks and responsibilities greatly complicates both product configuration of the ESP and the processing of customer projects. In addition, it is not possible to use tools for automated documentation generation in the three sectors mentioned.

### BRIEF SUMMARY OF THE INVENTION

It is an object of the present invention to create a method and an apparatus for improved determination of a target state in a system e.g., ESP, having multiple components, and to create a corresponding computer program and a computer program product.

The present invention makes available a method for determining a target state in a system having multiple components, system states of different priorities being selectable in the system as a function of an availability of the components. In accordance with the method according to the present invention, an ascertainment is made as to whether a highest-priority system state is selectable. If the highest-priority system state is selectable, the highest-priority system state is determined as the target state. If the highest-priority system state is not selectable, an ascertainment is made as to whether a next-highest-priority system state is selectable, as well as a determination of the next-highest-priority system state as the target state if the next-highest-priority system state is selectable.

The present invention further provides an apparatus for determining a target state in a system having multiple components, which apparatus carries out all the steps of the method according to the present invention.

The computer program according to the present invention, having program code means, is designed to carry out all the steps of the method according to the present invention when said computer program is executed on a computer or on a corresponding calculation unit, in particular an apparatus according to the present invention.

The computer program product according to the present invention, having program code means that are stored on a computer-readable data medium, is provided for carrying out the method according to the present invention when said computer program product is executed on a computer or on a corresponding calculation unit, in particular an apparatus according to the present invention.

An essential aspect of the invention is a so-called authorization manager, also called a “system release manager,” in which all the available system levels are defined. In addition, for each system level a list is provided of those signals required for operation of the respective level.

The approach according to the present invention makes it possible to ascertain at any time the system state that can still be occupied with regard to specific influencing factors. “Influencing factors” are to be understood, for example, as faults and stipulations. “Faults” encompass, for example, faults in a system-internal sensor suite or actuator suite, as well as faults in a sensor suite or actuator suite of outside systems. “Stipulations” encompass, for example, stipulations made by the driver or by the manufacturer. Stipulations or triggers effected by the driver occur, of course, during ongoing operation of the system. Stipulations made by the manufacturer can occur during production or during repair at repair shops. These also represent triggers for carrying out a system configuration. All these requests must be evaluated in such a way that safe operation with maximum possible system availability is ensured at all times.

The invention offers a number of implementation-independent advantages. These include the fact that, for example, only system levels defined in an “inhibit handler” can be occupied. System levels other than those defined are not possible. In addition, all system levels, and the conditions under which the levels can be occupied, are defined at a central location. The clarity of the system is thereby greatly enhanced. Dependences that are stored in the system release manager are highly project-dependent. Central definition of these dependences greatly reduces the outlay upon project initiation and in the course of a project.

As a rule, demands on the overall system also change in the course of project development. The range of system and software elements affected by these changes is very small. Centralization of the dependences makes analysis very much simpler, and involves substantially fewer persons. Tool-assisted analysis of hardware dependence implementation is greatly simplified, or made possible, by the central definition of dependences. Greatly improved capability for automatic documentation preparation is offered. An explicit definition of the permitted system states enables automated testing, and constitutes a foundation for easier reduction in complexity.

The invention further offers a number of implementation-relevant advantages. For example, very efficient algorithms, with which faults and triggers can be further processed, are used. The result is that fewer of the very limited resources in a control device—ROM, RAM, and run time or cycle time—are consumed.

Usefully, a lower- or lowest-priority system state is determined as the target state if the next-higher-priority system state is not selectable. With this action, the target state having the best possible priority can be selected or established in simple fashion at any point in time, and a graduated check of the system states in the order of their priorities (by descending priority) can be carried out.

It is preferred that the ascertainment step be carried out based on a central allocation table, such that the central allocation table defines, for each system state, which of the components must be available in order for the respective system state to be selectable. This feature makes possible, in particular, centralized definition, checking, re-establishment, and retrievability of all possible system states.

The ascertainment steps usefully encompass a step of analyzing whether the components necessary, in accordance with the central allocation table, for the particular system state are available.

The different priorities correspond, in this context, to different availabilities of the system, the highest-priority system state advantageously corresponding to a highest availability of the system.

It is preferred that a first set of available components be necessary for selectability of the highest-priority system state, and that a second set of available components be necessary for selectability of the next-higher-priority system state, such that the second set can be a subset of the first set. This action enables optimum coordination or gradation of the respective states.

Usefully, no available components are necessary for selectability of the lowest-priority system state. This enables, in particular, an emergency mode in certain circumstances.

According to an example embodiment of the method according to the present invention, in reaction to a change in an availability of one of the components, the target state of the system is re-ascertained starting from the highest-priority system state. It is thereby possible to ensure that an optimum system setting is possible at any time.

A change in an availability of one of the components can usefully occur as a result of a malfunction of the components, an intervention by a system user, and/or a stipulation by a manufacturer of the system. The method according to the present invention thereby permits adaptation of the system to the most probable malfunctions and to changes that must be accounted for.

Usefully, it is possible to indicate, by way of the target state, which functionalities of the system are operational. This enables a particularly clear presentation of the functionalities, thereby simplifying handling of the system. These functionalities are, by preference, controllers, model calculation functions, monitoring functions, or signal conditioning functions.

It is understood that the features recited above and those yet to be explained below can be used not only in the respective combination indicated, but also in other combinations or in isolation, without leaving the context of the present invention.

### BRIEF DESCRIPTION OF THE SEVERAL VIEWS OF THE DRAWINGS

FIG. 1 is a flow chart of a method in accordance with an embodiment of the present invention.

FIG. 2 is a block diagram of an apparatus in accordance with an embodiment of the present invention.

FIG. 3 shows an allocation table in accordance with an embodiment of the present invention.

### DETAILED DESCRIPTION OF THE INVENTION

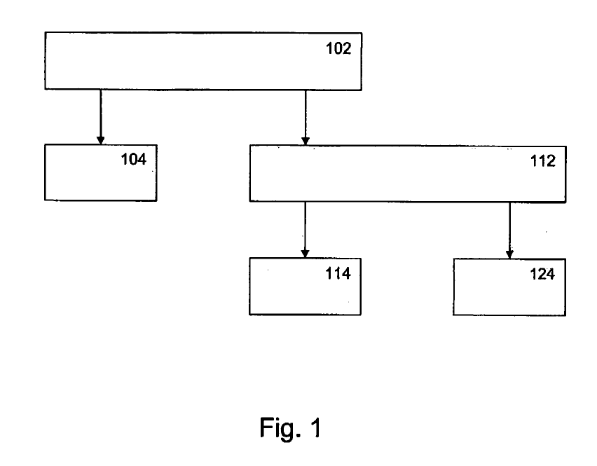

FIG. 1 is a flow chart for depiction of a method for determining a target state in a system having multiple components, in accordance with an exemplifying embodiment of the present invention. System states of different priorities can be selected in the system depending on an availability of the components.

A first method step 102 ascertains whether a highest-priority system state is selectable. The highest-priority system state is selectable when all the components of the system that are necessary for selection of that system state are available. If the highest-priority system state is selectable, i.e. if all the necessary components are available, the highest-priority system state is then ascertained, in a method step 104, as the target state. In this case the method can be terminated without executing further method steps.

If the highest-priority system state is not selectable, however, i.e. if all the necessary components are not available, a method step 112 then ascertains whether a next-higher-priority system state is selectable. The next-higher-priority system state is selectable when all the components of the system that are necessary for selection of that system state are available. Typically, fewer or different components are necessary for the next-higher-priority system state than for the higher-priority system state. For example, a subset of the components necessary for the higher-priority system state may be necessary for the next-higher-priority system state. If the next-higher-priority system state is selectable, i.e. if all the components necessary for that system state are available, the next-higher-priority system state is determined, in a method step 114, as the target state. In this case the method can be terminated.

If the next-higher-priority system state is not selectable, further system states each having lower priorities can then be checked, in further method steps (not shown in the Figures), as to their selectability. In this context a check is made with regard to priorities, in descending order, as to whether a system state is selectable. If a system state is selectable, that system state is selected as the target state. Otherwise an ascertainment is made as to whether the next-lower-priority system state is selectable. The method is carried out until a selectable system state has been ascertained and determined as the target state.

If no higher-priority system state is selectable, i.e. if (with reference to FIG. 1) the next-higher-priority system state is not selectable, a lowest-priority system state can then, in a further method step 124, be determined as the target state. For example, the lowest-priority system state can always be determined as the target state if sufficient components are not available for selection of a higher-priority system state.

Method steps 102, 104, 112, 114, 124 can be executed at a central location in the system. It is possible to use for this purpose, for example, a central allocation table (shown in FIG. 3) that defines, for each system state, which of the components must be available in order for the respective system state to be selectable. Using the central allocation table, it is possible to analyze whether the components necessary, according to the central allocation table, for the respective system state are available.

The different priorities of the system states can correspond to different availabilities of the system, the highest-priority system state corresponding to a highest system availability.

If a change occurs in an availability of a component, it may then be necessary to check the present existing target state or to determine a new target state. A change in the availability of one of the components can result, for example, from a malfunction of the component, an intervention by a user of the system, or a stipulation by a manufacturer of the system. A determination of a new target state that thereupon becomes necessary can be accomplished by carrying out the method according to the present invention again. With reference to FIG. 1, this means that a new target state is determined starting from the first method step 102.

The target state can define which functionalities of the system are operational. The functionalities can be, for example, controllers, model calculation functions, monitoring functions, or signal conditioning functions.

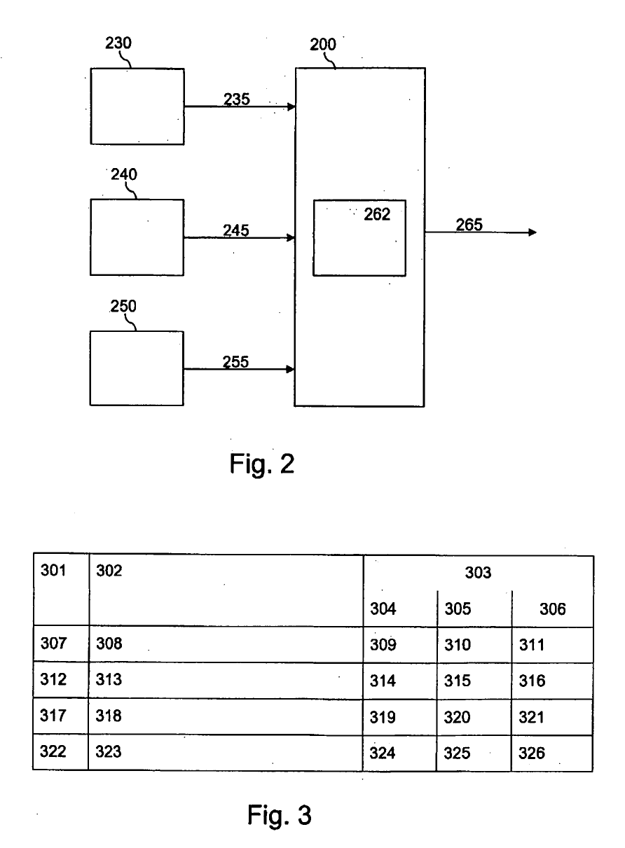

FIG. 2 is a block diagram for depiction of an apparatus 200 for determining a target state in a system having multiple components. FIG. 2 shows by way of example a system having a first component 230 whose availability in the system can be indicated by way of a first availability signal 235, a second component 240 whose availability can be indicated by way of a second availability signal 245, and a third component 250 whose availability can be indicated by way of a third availability signal 255. Apparatus 200 can be implemented in the system as a unit, i.e. not in distributed fashion. Apparatus 200 is embodied to receive availability signals 235, 245, 255. Apparatus 200 can have an allocation table 262. All possible system states are defined in allocation table 262. Allocation table 262 also defines, for each system state, which of the components 230, 240, 250 must be available in order for the respective system state to be selectable. For example, it may be necessary for all the components 230, 240, 250 to be available in order for the highest-priority system state to be selectable.

Apparatus 200 is embodied to ascertain, using allocation table 262 and by way of an evaluation of availability signals 235, 245, 255, which system state defined in allocation table 262 can be selected. Apparatus 200 is further embodied to determine as the target state that system state which can be selected on the basis of the available components and which additionally has the highest priority of all selectable system states. Apparatus 200 has means for indicating the target state in the form of a target state signal 265.

Components 230, 240, 250 can be, for example, sensors, actuators, data transfer controllers, control device components, or signals transferable by such components. The system can be, for example, a dynamic system such as a mechatronically embedded system.

Apparatus 200 or allocation table 262 can be implemented in the form of a system release manager that defines all system levels. The system release manager further defines, for each system level, those signals that are necessary for operation of that level.

With reference to FIG. 3 already mentioned, a simple example of a state definition in the system release manager will be described. FIG. 3 is a table which can be the allocation table 262 described in FIG. 2.

The table has three columns and five rows. The last column is subdivided into three subcolumns. The first column, which begins with field 301, defines the possible system states. The second column, which begins with field 302, defines the signals, components, and triggers necessary for the respective system state; these are referred to collectively as “guards.” The third column, which begins with field 303, defines system component states that depend on the signals, components, and triggers defined in the second column. Dependent components of this kind can be an ABS system presented in first subcolumn 304, an ASR system presented in second subcolumn 305, or an ESP system presented in third subcolumn 306.

The second row, which begins with field 307, describes a “system state 3” for which, in accordance with field 308, the “yaw rate,” “engine interface,” “four rotation speed sensors,” and “passive button” components must be available in order for the ABS component to be the “on” state in accordance with field 309, the ASR component to be in the “on” state in accordance with field 310, and the ESP component to be in the “on” state in accordance with field 311.

The third row, which begins with field 312, describes a “system state 2” for which, in accordance with field 313, the “engine interface-” and “four rotation speed sensors” components must be available in order for the ABS component to be in the “backup” state in accordance with field 314, the ASR component to be in the “backup” state in accordance with field 315, and the ESP component to be in the “off” state in accordance with field 316.

The fourth row, which begins with field 317, describes a “system state 1” for which, in accordance with field 318, the “four rotation speed sensors” component must be available in order for the ABS component to be in the “backup” state in accordance with field 319, the ASR component to be in the “off” state in accordance with field 320, and the ESP component to be in the “off” state in accordance with field 321.

The fifth row, which begins with field 322, describes a “system state 0” for which, in accordance with field 323, no components need to be available. The ABS component is in the “off” state in accordance with field 324, the ASR component is in the “off” state in accordance with field 325, and the ESP component is in the “off” state in accordance with field 326.

In the example described with reference to FIG. 3, there exist four system states 307, 312, 317, 322 that are placed in the table shown in FIG. 3 in accordance with their respective priorities. The priorities correspond to a system availability. In the table, system states 307, 312, 317, 322 are sorted in descending order. To ascertain the resulting target strategy, this table is traversed from top to bottom and the necessary signals 308, 313, 318, 323 are analyzed. If all the parts of the associated guard are available or met for a strategy, that is then the new target strategy, and the search is discontinued.

As is evident from the table, both signals (e.g. the yaw rate) and triggers (such as the passive button), and the availability of actuators (e.g. hydraulic valves), are listed among the guards 302. This shows that the inhibit handler makes no distinction among these guard elements. The inhibit handler is thereby considerably simplified, since one solution algorithm can be used for all types.

A few examples based on the table described in FIG. 3 will be presented below for explanation.

If the yaw rate sensor, all the rotation speed sensors on the wheels, and the engine interface are supplying valid signals, “strategy 3” is then selected. The search for a target strategy is then terminated.

If no faults exist in the system and the driver presses the passive button, “strategy 2” is selected. The reason is that the conditions for “strategy 3” are not met, since the passive button must not be pressed in that context.

If a rotation speed sensor on one wheel fails, the search for an implementable strategy then begins again with the topmost strategy. Because strategies 3 through 1 each require this sensor to be valid, “strategy 0” is selected. This system state can, in principle, always be occupied, since no signals are required for it. All components 304, 305, 306 of the system are deactivated in this context. This state is therefore referred to as “failsafe.”

The present invention may be implemented as software. The method according to the present invention provides a new method for managing system states of dynamic systems. This method contains a determination of the operating state that is permitted and desired under the existing boundary conditions, and that furthermore exhibits the greatest system availability.

The approach according to the present invention is not limited to an electronic stability program (ESP). Utilization is instead conceivable in all embedded mechatronic systems. Such systems are, for example, in addition to ESP, the ABS and ASR products. The above-described exemplifying embodiments from the ESP application serve merely for explanation, but in no way limit the field of application of the invention.

1-16. (canceled)

17. A method for determining a target state in a system having multiple components, system states of different priorities being selectable in the system as a function of availability of the components, the method comprising:
(a) ascertaining whether a highest-priority system state is selectable;
(b) determining the highest-priority system state as the target state if the highest-priority system state is selectable;
(c) if the highest-priority system state is not selectable, ascertaining whether a next-highest-priority system state is selectable; and
(d) determining the next-highest-priority system state as the target state if the next-highest-priority system state is selectable.

18. The method as recited in claim 17, wherein a system state lower than the next-highest-priority system state is determined as the target state if the next-highest-priority system state is not selectable.

19. The method as recited in claim 17, wherein the ascertainment in each of steps (a) and (c) is carried out based on a central allocation table, the central allocation table defining for each system state which of the components must be available in order for the respective system state to be selectable.

20. The method as recited in claim 19, wherein the ascertainment in each of steps (a) and (c) includes analyzing whether the components defined by the central allocation table as being necessary for the particular system state are actually available.

21. The method as recited in claim 19, wherein the different priorities correspond to different availabilities of the system, the highest-priority system state corresponding to the highest availability of the system.

22. The method as recited in claim 19, wherein a first set of available components is necessary for selectability of the highest-priority system state, and wherein a second set of available components is necessary for selectability of the next-highest-priority system state.

23. The method as recited in claim 22, wherein no available components are necessary for selectability of a lowest-priority system state.

24. The method as recited in claim 19, wherein if a change in an availability of one of the components occurs, the target state of the system is re-ascertained starting from the highest-priority system state.

25. The method as recited in claim 24, wherein the change in the availability of one of the components occurs as a result of at least one of: (i) a malfunction of at least one component; (ii) an intervention by a system user; and (iii) a stipulation by a manufacturer of the system.

26. The method as recited in claim 25, wherein the target state indicates which functionalities of the system are operational.

27. The method as recited in claim 26, wherein the functionalities of the system include at least one of controllers, model calculation functions, monitoring functions, and signal conditioning functions.

28. An apparatus for determining a target state in a system having multiple components, system states of different priorities being selectable in the system as a function of availability of the components, the apparatus comprising:
means for ascertaining whether a highest-priority system state is selectable;
means for determining the highest-priority system state as the target state if the highest-priority system state is selectable;
means for ascertaining whether a next-highest-priority system state is selectable, if the highest-priority system state is not selectable; and
means for determining the next-highest-priority system state as the target state if the next-highest-priority system state is selectable.

29. The apparatus as recited in claim 28, wherein the components include at least one of sensors, actuators, data transfer controllers, and control device components.

30. The apparatus as recited in claim 29, wherein the system is a mechatronically embedded system.

31. A computer-readable data storage medium storing a computer program having a plurality of program codes which, when executed on a computer, controls a method for determining a target state in a system having multiple components, system states of different priorities being selectable in the system as a function of availability of the components, the method comprising:
ascertaining whether a highest-priority system state is selectable;
determining the highest-priority system state as the target state if the highest-priority system state is selectable;
if the highest-priority system state is not selectable, ascertaining whether a next-highest-priority system state is selectable; and
determining the next-highest-priority system state as the target state if the next-highest-priority system state is selectable.
